(19) United States
(12) Patent Application Publication
(10) Pub. No.: US 2010/0212014 A1
(43) Pub. Date: Aug. 19, 2010

(54) Method for Detecting a Service Prevention Attack and Communication Terminal

(75) Inventors: Manfred Becker, Nurnberg (DE); Udo Doebrich, Karlsbad (DE); Roland Heidel, Kandel (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/676,416

(22) PCT Filed: Sep. 4, 2007
(86) PCT No.: PCT/EP2007/007875

§ 371 Date: Mar. 4, 2010

(51) Int. Cl. G06F 21/00

(52) U.S. Cl. 726/23

(57) ABSTRACT

A method for detecting a service prevention attack on a first communication terminal, wherein the detection of the service prevention attack is performed by the first communication terminal. The first and at least one second communication terminal comprise communication subscribers in a communication network. The communication connection is provided between the first and the second communication terminals. If the first communication terminal does not receive a status inquiry message of the second communication terminal in a timely manner, receipt of at least one further message indicating that the sender is the second communication terminal is interpreted as a service prevention attack on the first communication terminal and an action is taken, such as all or a plurality of packets are deleted from the input buffer memory or the connection between the two communication terminals is terminated.

The invention relates to a method for detecting a denial of service attack on a first communication terminal and a first communication terminal.

In communication networks different communication subscribers communicate with one another. Such communication networks can be wired (bus systems) or wireless (e.g. wireless LAN). The communication networks can be set up as internal to the device (bus system in SPS), automobile, machine, etc.), internal to the company (intranet, plant), cross-company or worldwide (internet).

It is possible to use certain facilities such as filters, firewalls, virus scanners or even the total isolation of the communication connection from the outside, etc. to protect the internal communication network against damage from outside, e.g. by way of the internet.

Denial of service attacks are carried out with malicious intent in a communication network by swamping a communication terminal in the communication network specifically with a plurality of messages, which the communication terminal cannot cope with in the available time with the existing structural design of the communication terminal. During a denial of service attack the communication terminal is unable to process the plurality of incoming messages and has to store these in an interim manner in a buffer, the size of which is however limited. However the buffer fills up very quickly and the buffer then no longer accepts any further messages. The messages already in the buffer are corrupted or overwritten. Generally the denial of service attack causes the affected communication terminals to fail, whereupon the higher-order communication network also collapses, which in turn results in malfunctions or breakdowns in installations controlled by the communication network.

The object of the invention is therefore to develop a technical solution for the prompt and reliable detection of a denial of service attack on a first communication terminal, thereby increasing the security of communication in the communication network.

According to the invention the object is achieved by a method for the detection of a denial of service attack on a first communication terminal by the first communication terminal, wherein

a) the first and at least one second communication terminal are communication subscribers in a communication network and a communication connection is set up between the first and second communication terminals,

b) the first communication terminal is to receive a status inquiry message from the second communication terminal at a specified time,

c) the timely receipt of the status inquiry message from the second communication terminal is monitored by means of a timer assigned to the first communication terminal,

d) the first communication terminal, when it does not receive the status inquiry message from the second communication terminal in a timely manner, if it still receives at least one further message, the message content of which indicates that the second communication terminal is the sender, interprets the receipt of this at least one further message as a denial of service attack on the first communication terminal and takes action.

According to the invention the object is also achieved by a first communication terminal for implementing the method steps of the method as claimed in one of claims 1 to 11 operating in the first communication terminal.

The inventive method and the inventive first communication terminal bring about the prompt and reliable detection of a denial of service attack on the first communication terminal, thereby increasing the security of communication in the communication network.

Developments of the invention will emerge from the subclaims.

The method is advantageously developed so that the action taken by the first communication terminal brings about the removal of the at least one further message buffered in a storage unit of the first communication terminal from the storage unit. This allows only the further message which was in fact generated by the denial of service attack to be deleted selectively, without deleting messages stored in the storage unit before the existence of the denial of service attack.

In a further advantageous manner the solution set out in the paragraph above is developed and the content of the storage unit is deleted totally. This allows a message overflow in the storage unit due to the denial of service attack to be prevented in a technically simple manner, although it means that messages stored in the storage unit which are not due to the denial of service attack are also deleted at the same time.

In a further advantageous manner the solution set out in the paragraph above is developed in that only the at least one further message, which was or is stored in the storage unit within a predetermined time in relation to the lack of timely receipt of the status inquiry message from the second communication terminal, is deleted from the storage unit. This represents a compromise solution, where possible deleting only the further messages stored in the storage unit which are due to the denial of service attack and not messages which are not due to the denial of service attack.

In a further advantageous manner the method is developed in that the action taken by the first communication terminal is to output a warning message that a denial of service attack on the first communication terminal is present to other communication subscribers in the communication network and/or to a communication network monitoring facility. This allows other communication subscribers to switch to security mode, thereby preventing any damage due to the service refusal. The search for the initiator of the denial of service attack can also take place immediately so that normal communication between the communication subscribers can be quickly resumed.

In a further advantageous manner the method is developed in that the first communication terminal is to receive status inquiry messages from the second communication terminal repeatedly at specified times and the first communication terminal, when it does not receive a predetermined number of status inquiry messages from the second communication terminal in a timely manner, if it still receives at least one further message, the message content of which indicates that the second communication terminal is the sender, interprets the receipt of this at least one further message as a denial of service attack on the first communication terminal and takes action. This prevents the action being instituted when a status inquiry message from the second communication terminal does not reach the first communication terminal due to some communication error.

In a further advantageous manner the method is developed such that the first communication terminal only takes action after a predetermined number of received further messages, the message content of which indicates that the second communication terminal is the sender. Because in practice denial of service attacks comprise a large plurality of further messages, it is then possible to distinguish a denial of service attack from normal message traffic with greater certainty.

In a further advantageous embodiment of the method according to one of the two paragraphs above, the method is applied in respect of status inquiry messages which are to be received cyclically or periodically by the first communication terminal. This allows a clear assignment to be established between a denial of service attack and the lack of receipt of defined status inquiry messages.

In one development of the method according to the above paragraph, the status inquiry messages are life cycle messages or communication subscriber verification return messages. These messages, which are widely used in communication networks, are particularly suitable for the method.

In one development of the method the method can also advantageously be applied, when the at least one further message is a status inquiry message. This closes a possible gap in the detection of denial of service attacks.

In one development of the method the method can also advantageously be applied, when only the first and second communication terminals are communication subscribers in the communication network. This also extends the field of application of the method to a communication network, which only consists of two communication subscribers.

Further advantages of the invention will emerge from the description which follows, which describes the invention based on four exemplary embodiments in conjunction with the accompanying drawings of schematic diagrams, in which:

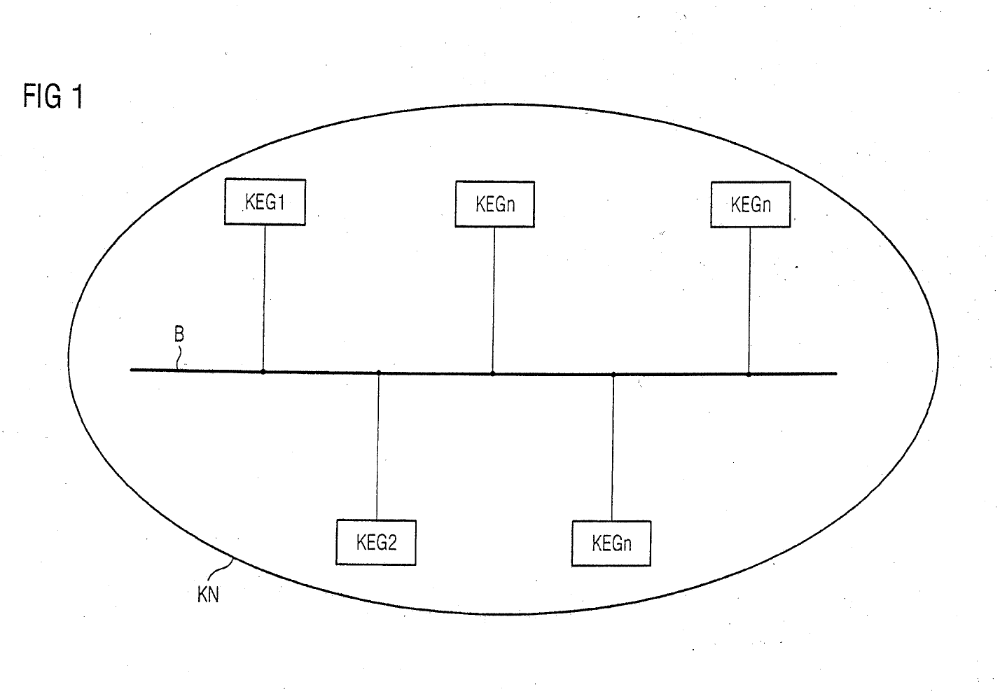

FIG. 1 shows an internal company communication network with a first communication terminal, a second communication terminal and three further communication terminals, which are connected respectively to a bus and

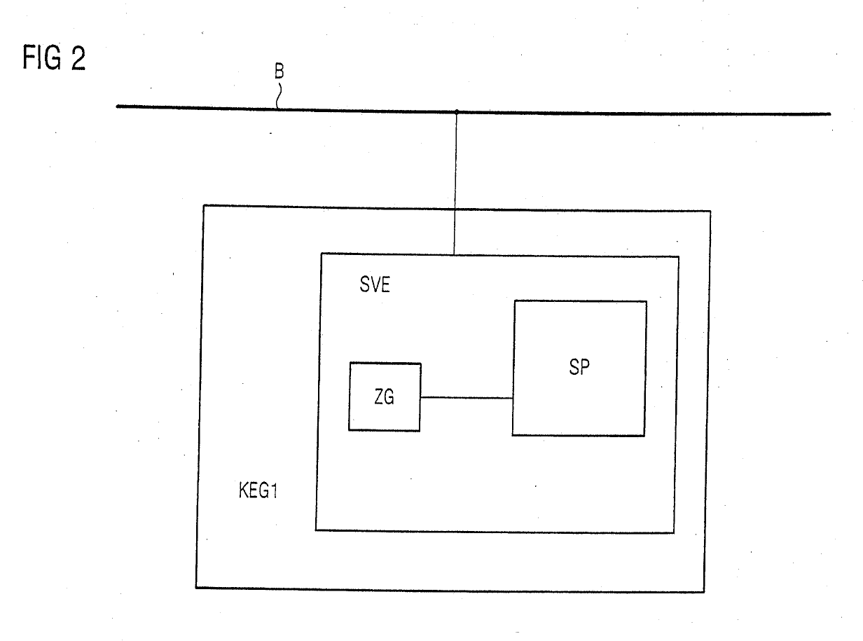

FIG. 2 shows the structural design of the first communication terminal and

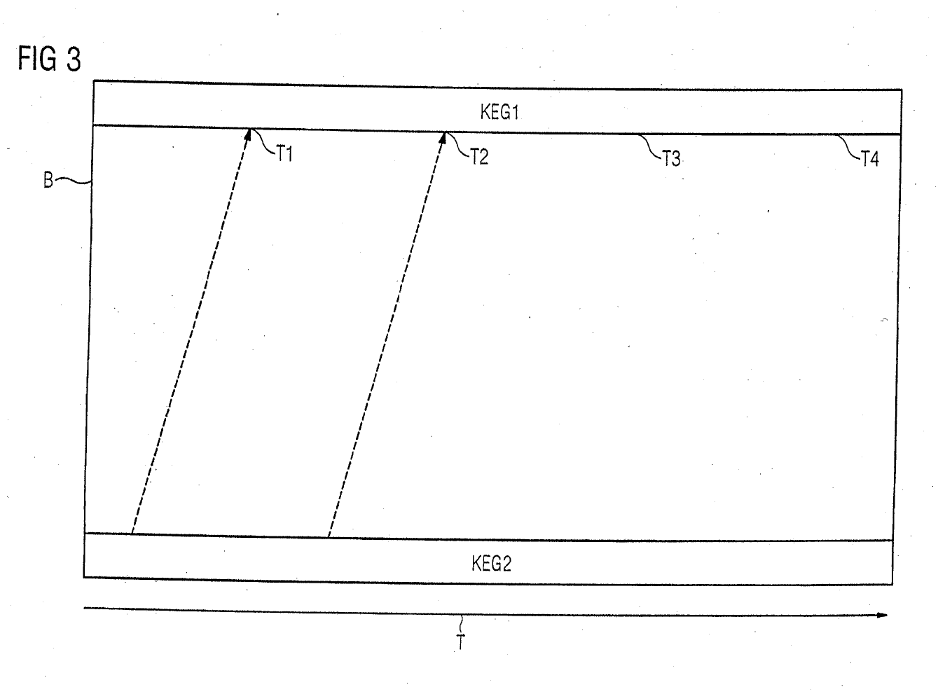

FIG. 3 shows the time sequence of the arrival or failure to arrive of status inquiry messages in the first communication terminal, having been sent by the second communication terminal and

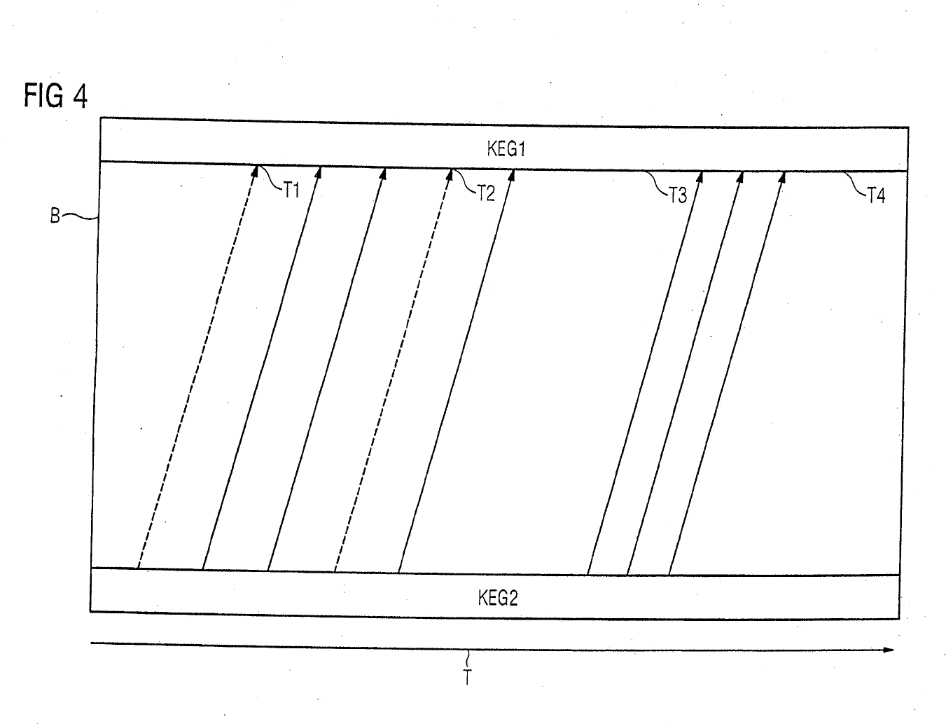

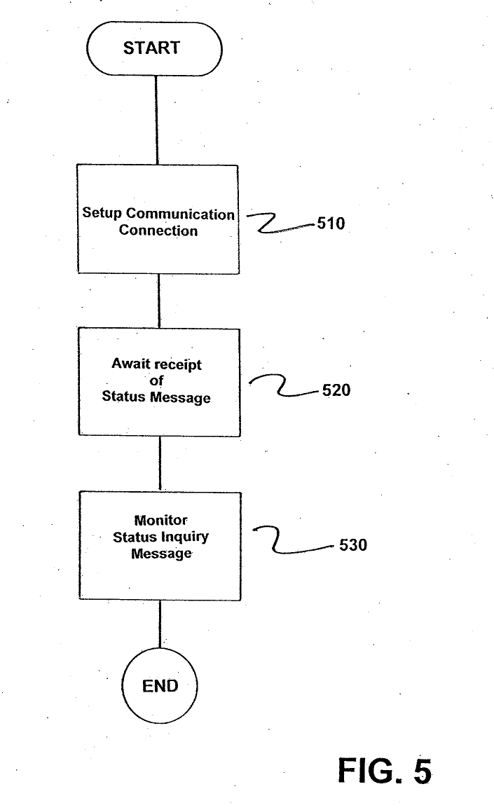

FIG. 4 shows the time sequence of the arrival or failure to arrive of status inquiry messages in the first communication terminal and the time sequence of the arrival of further messages in the first communication terminal.

FIG. 1 shows an internal company communication network KN, the limits of which are shown by the oval boundary line. The communication network KN comprises a first communication terminal KEG1, a second communication terminal KEG2 and three further communication terminals KEGn, which are connected respectively to a bus B. Further interfaces with communication partners inside and outside the company are possible but are not shown here. The invention is not restricted to internal company communication networks KN but there are, as already mentioned in the sections relating to the prior art, other options for protection against denial of service attacks by external communication subscribers.

The communication terminals KEG1, KEG2, KEGn can exchange messages with one another by way of the bus B. Specific protocols are used to set up a communication connection and then exchange messages. These communication protocols describe the structure of the data packets to be exchanged and typically contain data relating to the sender and recipient of the data packet, the type of data packet (signaling data e.g. connection set-up packet, connection termination packet, status inquiry message or payload), the packet length and a checksum. The protocols are organized in layers (OSI layer model), the protocols of higher layers using services of protocols of lower layers. The internet protocol TCP/IP has a similar structure, which is well known to the person skilled in the art and therefore requires no further explanation.

A communication connection was established between the first and second communication terminals KEG1, KEG2 as a result of the exchange of connection set-up packets and further messages can now be exchanged. Status inquiry messages are also exchanged between the two communication terminals KEG1, KEG2, as explained in detail below.

A denial of service attack could now be made by the second communication terminal KEG2 as the attacker on the first communication terminal KEG1, in which process the first communication terminal KEG1 would be overwhelmed with further messages. The invention is also intended to cover this instance where the denial of service attack is initiated by the second communication terminal KEG2. In this instance the further communication subscribers KEGn are not required (not shown here); the communication network can comprise just the first and second communication terminals KEG1, KEG2 here. In this instance however the malicious intent can be detected quickly by the first communication terminal KEG1, as the first and second communication terminals KEG1, KEG2 are generally designed to transmit and process a certain quantity of information and no further communication terminals KEGn are connected to the communication network KN (not shown here). When the first communication terminal KEG1 is swamped by a plurality of messages from the second communication terminal KEG2 and the malicious intent of the second communication terminal KEG2 is detected by the first communication terminal KEG1, a countermeasure, such as connection termination, is therefore initiated quickly by the first communication terminal KEG1.

However the denial of service attack is generally initiated by a further communication terminal KEGn. If the connection between the first and second communication terminals KEG1, KEG2 is set up, the plurality of further messages, i.e. the denial of service attack, are generated by one of the further communication terminals KEGn but with the sender information of the further communication terminal KEGn being exchanged for that of the second communication terminal KEG2 in the address field of the respective further messages (data packets). It appears to the recipient of the data packets as if the denial of service attack is brought about by the second communication terminal KEG2. The source of the denial of service attack, in this instance the further communication terminal KEGn, cannot however be detected in a simple manner.

FIG. 2 shows the structural design of the first communication terminal KEG1, which is connected to the bus B as described above in FIG. 1, and can exchange data packets with other communication subscribers KEG2, KEGn in the communication network KN (not shown here) by way of said bus B. The first communication terminal KEG1 comprises a control and processing unit SVE and the control and processing unit SVE comprises a timer ZG and a storage unit SP connected to the timer ZG. The timer ZG could of course also be arranged outside the first communication terminal KEG1 but must then be connected to the control and processing unit SVE by way of a data line (not shown here). The control and processing unit SVE is connected to the bus B. The second communication terminal KEG2 and the further communication terminals KEGn have the same structure (not shown here).

FIG. 3 shows the time sequence of the arrival of status inquiry messages in the first communication terminal KEG1, as sent by the second communication terminal KEG2 by way of the bus B. The time axis T is the x-axis. When a communication connection has been set up between the first and second communication terminals KEG1, KEG2, as described above, messages can be exchanged between the first and second communication terminals KEG1, KEG2. These messages also comprise signaling messages. One of these signaling messages is referred to henceforth as a status inquiry message. The status inquiry messages are generated automatically by the second communication terminal KEG2, in other words it is not possible to intervene in their generation by way of the user interface of the second communication terminal KEG2. The status inquiry message is different with regard to message structure from the further message and can therefore be distinguished by the first communication terminal KEG1 from the different structure of the message. These status inquiry messages sent repeatedly by the second communication terminal KEG2 generally (also repeatedly) arrive in the first communication terminal KEG1. The invention is also intended to cover the instance where, after a communication connection has been set up between the first and second communication terminals KEG1 and KEG2, only a single status inquiry message is sent by the second communication terminal KEG2 (not shown here).

The important thing about these status inquiry messages is that the first communication terminal KEG1 knows from the agreed network protocol when a status inquiry message from the second communication terminal KEG2 is to arrive in the first communication terminal KEG1. In FIG. 3 this is shown by the time points T1 to T4. The arrival time of the status inquiry message is monitored by means of the timer ZG in the first communication terminal KEG1. If status inquiry messages are sent repeatedly from the second communication terminal KEG2, this generally happens cyclically or periodically. These status inquiry messages should then also arrive cyclically or periodically in the first communication terminal KEG1 at a time known beforehand by the first communication terminal KEG1. FIG. 3 shows that the first status inquiry message (left dashed arrow) from the second communication terminal KEG2 arrives at the predetermined time point T1, in other words in a timely manner. The second status inquiry message (right dashed arrow) from the second communication terminal KEG2 also arrives in the first communication terminal KEG1 in a timely manner at the time point T2. A third and fourth status inquiry message from the second communication terminal KEG2 should arrive in the first communication terminal KEG1 at the time points T3 and T4 but this is not the case here (no dashed arrows in FIGS. 3 at T3 and T4).

The status inquiry messages can be what are known as life cycle messages for example. These life cycle messages are generally sent periodically by the second communication terminal KEG2 and should therefore also arrive periodically, i.e. within an already known time frame, at the first communication terminal KEG1. The arrival of the life cycle messages signals to the first communication terminal KEG1 that the second communication terminal KEG2 is still connected to the communication network KN and is available for data communication with the first communication terminal KEG1.

Another status inquiry message is what is known as a communication subscriber verification return message or polling. Here the first communication terminal KEG1 cyclically requests the status of the second communication terminal KEG2 and also the status of further communication terminals KEGn. In other words the respective bus addresses are requested. The second communication terminal KEG2 and also the further communication terminals KEGn have to reply to this status inquiry message within a specified time. If the first communication terminal KEG1 does not receive a return message from the second communication terminal KEG2, the second communication terminal KEG2 is isolated from the communication network KN and cannot maintain a communication connection with the first communication terminal KEG1. This status inquiry message is also used to detect new communication network subscribers.

The status inquiry messages are frequently generated by the first communication terminal KEG1, sent to the second communication terminal KEG2 and then mirrored by the second communication terminal KEG2 and sent back to the first communication terminal KEG1. With this mirroring method the status inquiry message also originates from the second communication terminal, even if not originally, so the invention also covers this mirroring of status inquiry messages.

The lack of timely receipt of the status inquiry message(s) by the first communication terminal KEG1 can however be used by the first communication terminal KEG1 for the purposes of detecting a denial of service attack on the first communication terminal KEG1, as shown in FIG. 4, which is a development of FIG. 3, so that all the designations correspond to those of FIG. 3.

Between the time points T1 and T3 the first communication terminal KEG1 receives further messages (shown as solid arrows) from the second communication terminal KEG2, with two further messages arriving at the first communication terminal KEG1 between the time points T1 and T2 and a further message between the time points T2 and T3. The further messages are not subject to any cycle or periodicity. A third and fourth status inquiry message from the second communication terminal KEG2 should arrive in the first communication terminal KEG1 at the time points T3 and T4 but this does not happen (shown by undrawn dashed arrows, which end at T3 and T4).

If the first communication terminal KEG1, after not receiving the status inquiry message from the second communication terminal KEG2 in a timely manner, still receives at least one further message, the message content of which indicates that the second communication terminal KEG 2 is the sender, the first communication terminal KEG1 interprets this state, i.e. receipt of this further message, as a denial of service attack on the first communication terminal KEG1 and then takes a predetermined action. This happens in FIG. 4 between time points T3 and T4. In this time period three further messages (shown as solid arrows) are received in the first communication terminal KEG1, their respective message content indicating that the second communication terminal KEG2 is the sender. Interpretation of this by the first communication terminal KEG1 as a denial of service attack is assumed, as either the second communication terminal KEG2 is no longer able to communicate with the first communication terminal KEG1, in which case the first communication terminal KEG1 should not receive either status inquiry messages or further messages from the second communication terminal KEG2 (the communication connection between the first and second communication terminals KEG1, KEG2 is isolated here) or the second communication terminal KEG2 is able to communicate with the first communication terminal KEG1 as before, in which case the first communication terminal KEG1 should receive both status inquiry messages and also further messages from the second communication terminal KEG2.

The person skilled in the art will optimize this method in respect of its susceptibility to error and will specify a) how many unreceived status inquiry messages are required and/or b) how many further messages have to arrive, to assume a denial of service attack. If a predetermined status inquiry message from the second communication terminal KEG2 is not received within the specified time, the timer ZG outputs an interrupt signal, which is used by the control and processing unit SVE of the first communication terminal KEG1 for the action to be taken. Generally the first communication terminal KEG1 is swamped with a plurality of further messages during a denial of service attack, so that these cannot be processed in the time provided and have to be buffered in the storage unit SP. However buffering is only a very short term solution, as the storage unit very soon overflows due to the plurality of incoming further messages and paralyzes the first communication terminal KEG1.

The person skilled in the art will optimize the method so that the “artificially generated further messages”=denial of service attack can be distinguished where possible from the “correctly generated further messages”, with the “artificially generated further messages” being removed from the storage unit SP. The control and processing unit SVE decides whether further messages reach the storage unit SP, with further messages, which have an incorrect message structure or in which the checksum (cyclic redundancy check CRC) is wrong, not being routed to the storage unit SP anyway. The checking and storage of further messages is generally carried out by the data backup layer (layer 2) of the OSI layer model.

The removal of all further messages from the storage unit SP is realized in a technically simple manner here, in other words the storage unit SP is totally deleted. However correctly generated further messages are also rejected in the process, which is generally not a problem, as the corresponding information can be received again in the next data exchange.

Isolation based on the data content of the data packets is also technically possible. It is also possible to use temporal relationships of the storage of further messages in relation to the lack of receipt of the status inquiry message to select and reject “artificially generated further messages” in contrast to the “correctly generated further messages”.

Even if “correctly generated further messages” have been deleted from the storage unit SP, these messages can be restored later by higher application layers of the control and processing unit SVE of the first communication terminal KEG1 after the denial of service attack has been dealt with. Use is made here of the fact that the individual further messages (data packets) are numbered continuously and the first communication terminal KEG1 can then request the missing data packets again from the second communication terminal KEG2.

The storage unit SP is totally deleted or the “artificially generated further messages” are removed from the storage unit SP until a status inquiry message from the second communication terminal KEG2 is received in a timely manner again by the first communication terminal KEG1.

During the denial of service attack the first communication terminal KEG1 can also switch to a secure operating mode to prevent further damage to the first communication terminal KEG1.

If the first communication terminal KEG1 ascertains a denial of service attack on the first communication terminal KEG1, it will output a warning message about the denial of service attack to the other communication subscribers KEG2, KEGn and to a communication network monitoring facility (not shown here). The other communication subscribers (KEG2, KEGn) can also switch to a secure operating mode during the denial of service attack and the communication network monitoring facility will start the search for the attacker in the communication network KN and, if it is ascertained, appropriate measures can be instituted, for example the isolation of the attacker from the communication network KN.

The invention also covers the use of status inquiry messages as further messages for the purposes of the denial of service attack. Here too the first communication terminal KEG1 would detect that these are not arriving in a timely manner (too early or too late) and if these events exceed a predetermined number, this is interpreted by the first communication terminal KEG1 as a denial of service attack and the actions described above are triggered.

The invention is not restricted to the specific exemplary embodiment but also covers further modifications that are not explicitly disclosed, as long as use is made of the core of the invention.

1.-12. (canceled)

13. A method for detecting a denial of service attack on a first communication terminal by the first communication terminal, comprising:
setting up a communication connection between the first and at least one second communication network, the first and the at least one second communication terminal comprising communication subscribers in a communication network and a communication connection is set up between the first and second communication terminals;
awaiting receipt at the first communication terminal of a status inquiry message from the at least one second communication terminal at a specified time; and
monitoring, at a timer assigned to the first communication terminal, for the receipt of the status inquiry message from the at least one second communication terminal to determine whether the status message is received in a timely manner;
wherein when the first communication terminal does not receive the status inquiry message from the second communication terminal in the timely manner, if first communication terminal still receives at least one further message, a message content of which indicates that the at least one second communication terminal is the sender, the first communication terminal interprets the receipt of the at least one further message as a denial of service attack on the first communication terminal and takes action, and
wherein the action taken by the first communication terminal causes removal of the at least one further message buffered in a storage unit of the first communication terminal from the storage unit.

14. The method as claimed in claim 13, wherein the action taken by the first communication terminal cause complete deletion of the content of the storage unit.

15. The method as claimed in claim 13, wherein the action taken by the first communication terminal comprises deleting only the at least one further message, which was previously or currently stored in the storage unit within a predetermined time of untimely receipt of the status inquiry message from the second communication terminal, from the storage unit.

16. The method as claimed in claim 13, wherein the action taken by the first communication terminal further causes outputting to at least one of other communication subscribers in the communication network and a communication network monitoring facility a warning message indicating a denial of service attack is present at the first communication terminal.

17. The method as claimed in claim 13, wherein the first communication terminal repeatedly awaits receipt of status inquiry messages from the second communication terminal at the specified time, and when the first communication terminal does not receive a predetermined number of status inquiry messages from the at least one second communication terminal in a timely manner, if the first communication terminal still receives at least one further message, the message content of which indicates that the at least one second communication terminal is a sender of the at least one further message, interprets receipt of the at least one further message as a denial of service attack on the first communication terminal and takes action.

18. The method as claimed in claim 13, wherein the first communication terminal only takes action after a predetermined number of the received at least one further message, the message content of which indicates that the at least one second communication terminal is the sender of the at least one further message.

19. The method as claimed in claim 17, wherein the first communication terminal only takes action after a predetermined number of the received at least one further message, the message content of which indicates that the at least one second communication terminal is the sender of the at least one further message.

20. The method as claimed in claim 17, wherein status inquiry messages are received one of cyclically or periodically by the first communication terminal.

21. The method as claimed in claim 19, wherein status inquiry messages are received one of cyclically or periodically by the first communication terminal.

22. The method as claimed in claim 17, wherein the status inquiry message comprises one of life cycle messages or communication subscriber verification return messages.

23. The method as claimed in claim 13, wherein only the first and the at least one second communication terminal comprise communication subscribers in the communication network.

24. A communication terminal, comprising:
an interface for exchanging data packets with other communication subscribers in a communication network;
a control and processing unit,
a timer; and
a storage unit;
wherein the communication terminal is configured to receive a status inquiry message from another communication subscriber at a specified time interval, and the timer is configured to monitor timely receipt of the status inquiry message;
wherein the communication terminal is further configured such that when the communication terminal does not receive the status inquiry message in a timely manner, if the communication terminal receives at least one further message, a message content of which indicates that a second communication terminal is the sender of the at least one further message, the communication terminal interprets receipt of the at least one further message as a denial of service attack; and
wherein the control and processing unit is configured to remove the at least one further message, which is buffered in the storage unit, from the storage unit.
